(19) United States
(12) Patent Application Publication
(10) Pub. No.: US 2003/0008641 A1
(43) Pub. Date: Jan. 9, 2003

(54) Identifying multilingual participants in network communications

(76) Inventor: Sundaram Ramakesavan, Chandler, AZ (US)

Correspondence Address: Timothy N. Trop, TROP, PRUNER & HU, P.C., STE 100, 8554 KATY FWY, HOUSTON, TX, 77024-1805, US

(21) Appl. No.: 09/899,464

(22) Filed: Jul. 5, 2001

(51) Int. Cl. H04M 3/42

(52) U.S. Cl. 455/416; 455/566

(57) ABSTRACT

An ad hoc wireless network may facilitate identification of participants whose personal computers or other devices utilize an incompatible character set. Thus, users with incompatible character sets may not be identified on display screens associated with the various participants in a compatible character set that may be understood by all participants. Thus, other identifying information may be provided and may be displayed automatically or on demand. Examples of such identifying information include identifying icons, audio files and image files.

### BACKGROUND

This invention relates generally to establishing ad hoc wireless networks.

Ad hoc wireless networks involve the establishment of a communications session between a plurality of devices operating under a common wireless communication protocol. Examples of such wireless communication protocols include the Bluetooth protocol (See the Specification of the Bluetooth System, Version 1.1 (Feb. 22, 2001) available from the Bluetooth Special Interest Group) and the I.E.E.E. 802.11 protocol (See Institute of Electrical and Electronics Engineers, Inc. (I.E.E.E.) Std. 802.11, 1999 Edition, “Wireless LAN Medium Access Control and Physical Layer Specification” available from the I.E.E.E. Inc., New York, N.Y. 10016-5997, U.S.A.) In an ad hoc wireless network, a plurality of users may communicate with one another over a wireless link. The participants may be ultimately linked over other types of networks including the Internet. Conventionally, the ad hoc wireless network is established using protocols that search out and locate the participants. Once the participants are enumerated, they may be identified on a display screen associated with each device.

Thus, in one example, wireless cell phones may communicate with personal computers, which in turn communicate over the Internet. Each participant in an ad hoc wireless network may automatically be provided with a screen display indicating the other participants.

Each of the participants may be identified in such displays by their text name. However, when participants from countries that use different character sets are involved, their native characters may not translate in all cases. For example, a person using English script in the United States who is communicating with someone in Japan may be unable to read the Japanese characters because the script to convert the Japanese characters to English characters may not be available on the English user's computer and vice versa.

In an ad hoc network in which only one user with a different character set is involved, by deduction, that user may be identified. However, when multiple users with incompatible character sets are involved, each of the users may be unable to determine which of the two incompatible character set users is which. Therefore, it may be difficult to fully utilize the ad hoc wireless network because the participants can not distinguish between the incompatible character set users and, therefore, may not direct communication specifically to one or the other of those users. As a result, advantages of wireless ad hoc networks may be diminished in cases where incompatible character sets are involved.

Therefore, there is a need for a way to identify persons participating in ad hoc wireless networks between users with incompatible character sets.

### BRIEF DESCRIPTION OF THE DRAWINGS

FIG. 1 is a schematic depiction of an ad hoc wireless network in accordance with one embodiment of the present invention;

FIG. 2 is an identifying screen display in accordance with the prior art;

FIG. 3 is a depiction of a screen display in accordance with one embodiment of the present invention;

FIG. 4 is a depiction of a screen display in accordance with one embodiment of the present invention;

FIG. 5 is a flow chart for SEND software in accordance with one embodiment of the present invention;

FIG. 6 is a flow chart for RECEIVE software in accordance with one embodiment of the present invention; and

FIG. 7 is a block depiction of a wireless communication terminal in accordance with one embodiment of the present invention.

### DETAILED DESCRIPTION

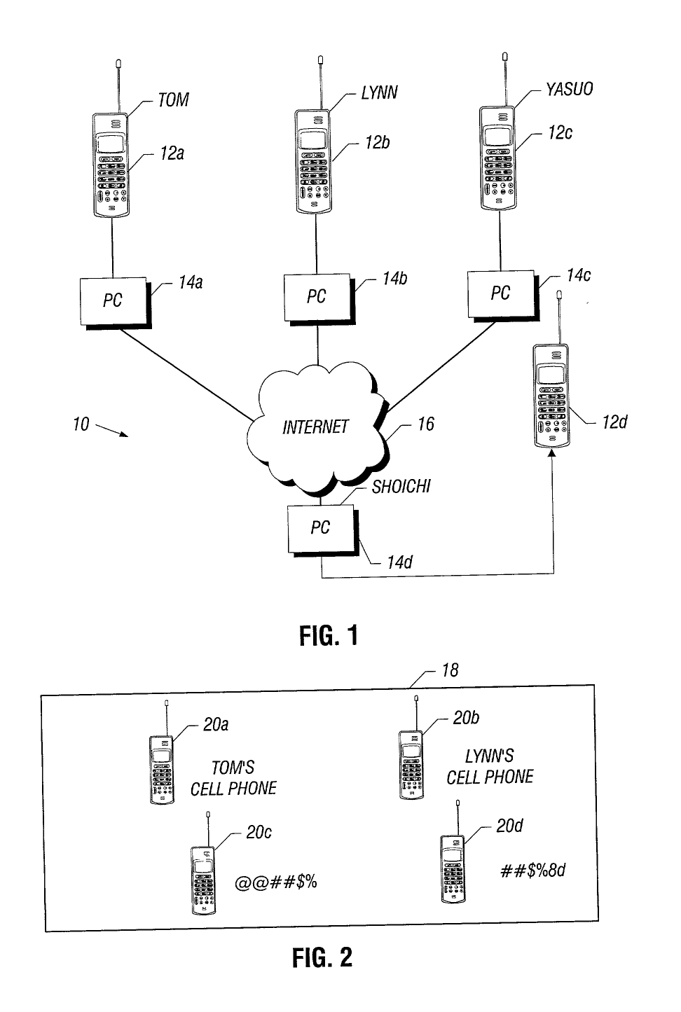

Referring to FIG. 1, an ad hoc wireless network may be set up at any time between a plurality of users having compatible systems. Thus, each of the users may have a portable computer 14, which implements a wireless communication protocol between the portable computer 14 and the owner's cellular telephone 12 in one embodiment. Communications may be provided over the Internet 16. As a result, each of the plurality of users may establish a communications session for an ad hoc wireless communication network, which enables any of the participants to communicate with one another. The link between the cellular telephone 12a and the personal computer 14a, for example, may be via an appropriate wireless protocol. Examples of suitable wireless protocol include the Bluetooth protocol and the IEEE 802.11 protocol.

In the example illustrated in FIG. 1, the owners of the cellular telephones 12c and 12d are in Japan and their personal computers 14c and 14d utilize the Japanese character set. At the same time, the participants owning the cellular telephones 12a and 12b are in the United States and their owners have personal computers 14a and 14b which use the English character set. In this example, the personal computers 14a and 14b do not have the script to convert the Japanese characters for display. As a result, as shown in FIG. 2, a screen display 18 may automatically reveal the participants in the ad hoc wireless network. Each participant may be identified by a cell phone symbol 20, in one embodiment, together with the participant's name. However, screen display 18, shown in association with either of the personal computers 14a or 14b that do not include Japanese characters simply insert meaningless characters for the names of the Japanese participants because of the absence of suitable character set translation software on the personal computers 14a and 14b. The same situation would exist for the Japanese participants if their computers did not have the software to convert the English text, but instead, solely handled Japanese character sets.

As a result, a participant in the United States having the screen display 18 may not be able to identify which of the users is Yasuo and which of the users is Shoichi from the apparent information on the display 18. Therefore, it may not be easy to determine how to send a particular communication to one, but not both of those foreign character set users.

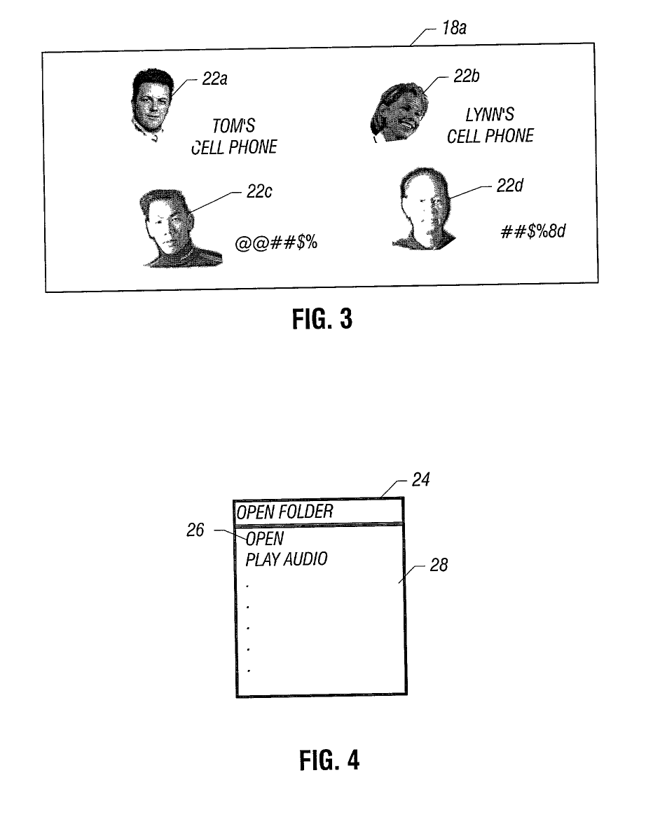

Turning to FIG. 3, a screen display 18a in accordance with one embodiment of the present invention may include identifying photographs 22 to identify each of the users. Thus, while the incompatible character sets may not complete the correct names, the user images may be utilized to distinguish between the various users in one embodiment of the present invention. In other embodiments, audio files may be utilized to identify each user. For example, each user may say the user's name and when any user clicks on an image associated with a particular user, such as the image 20a shown in FIG. 2, the user's name will be played back. In still another embodiment, each user may be associated with an unique symbol that identifies the user. In one such case, the unique symbol may be a depiction of the user's name in a compatible character set. For example, the Japanese user may provide a file which includes the English characters for that user's name.

As shown in FIG. 4, when the user clicks on one of the cellular phone images 20 shown in FIG. 2, a dropdown menu 24 may appear. The user can then click on one of the entries 26, such as the OPEN entry, to obtain more information about the user. Alternatively, the user may select the PLAY AUDIO entry to hear the user say the user's name.

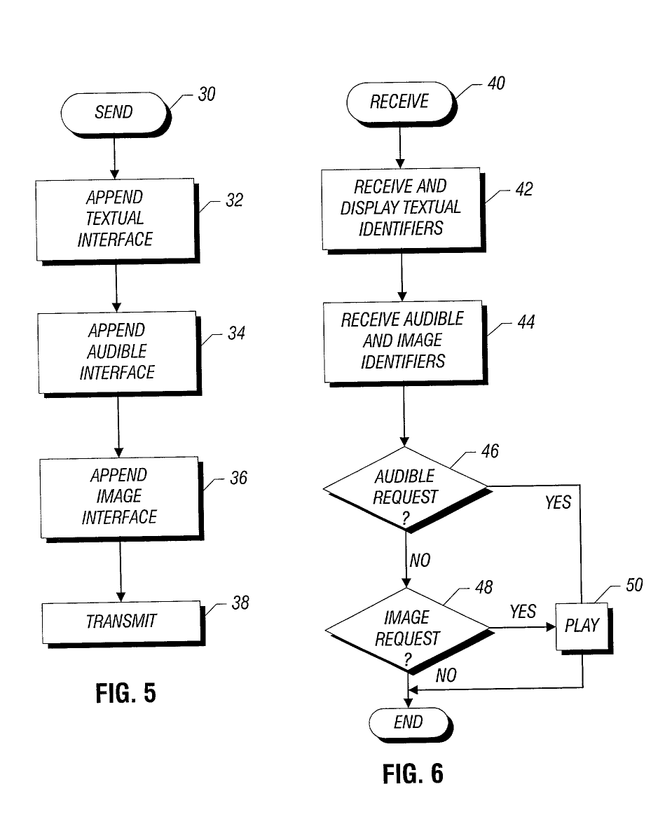

The SEND software 30 for implementing one embodiment of the present invention, prompts the user to append a textual interface as indicated in block 32 of FIG. 5. Thus, the user's personal computer may automatically append the user's name for display on display screens 18 associated with personal computers 14 of other participants in an ad hoc wireless network. In addition, the audible interface may be appended as indicated in block 34. The user may be asked, for example, through a graphical user interface, to provide an audible recording of the user's name. Next, the user may be asked to supply an image, for example, through a digital camera associated with the personal computer 14, as indicated in block 36. Finally, one or more of the interface information may be automatically transmitted as indicated in block 38 to the other enumerated participants in the ad hoc wireless communication.

In FIG. 6, each of the participants then receives a communication from the other participants using the software 40 in accordance with one embodiment of the present invention. As indicated in block 42, each participant's personal computer 14 receives and displays textual identifiers. Similarly, a personal computer 14 receives and displays audible and image identifiers as indicated in block 44. Upon a request for audible identifiers, as determined at diamond 46, the audible identifier may be played as indicated in block 50. If, instead, the user requests the image, as indicated in block 48, it may be displayed as well. Thus, in some embodiments, the screen display may be as shown in FIG. 2 and the images are only provided upon request and selection. Similarly, the audible information may only be provided upon request and selection.

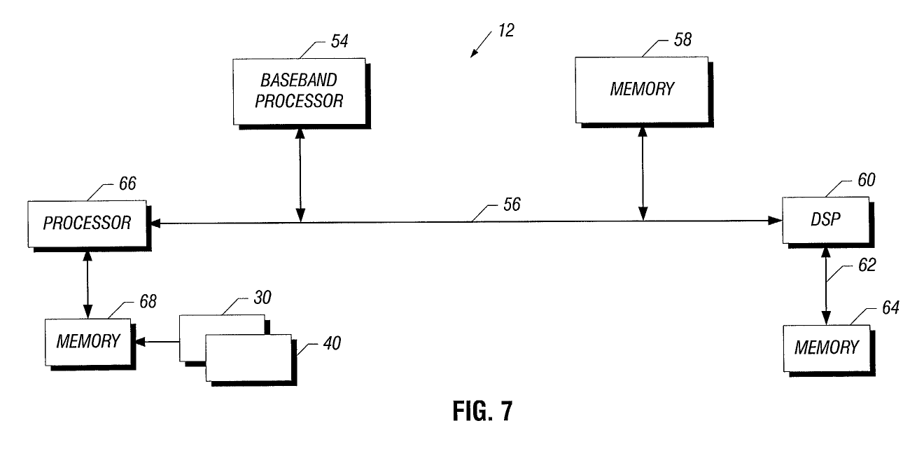

Referring to FIG. 7, in accordance with one embodiment of the present invention, each of the cellular telephones 12 may include a bus 56, which is coupled to a baseband processor 54 and a memory 58. A digital signal processor (DSP) 60 may also be coupled to the bus 56, as well as over a bus 62 to a memory 64. An additional general-purpose processor 66 coupled to the bus 56 may have its own memory 68 in one embodiment. In one embodiment, the software 30 and 40 may be stored in that memory 68. In other embodiments, the software 30 and 40 may be stored in the peripheral computers 14.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving character set independent information about a participant in an ad hoc wireless network; and
displaying said information to enable selection of a participant for a communication.

2. The method of claim 1 wherein receiving character set independent information about a participant includes receiving an audio file that identifies a participant.

3. The method of claim 1 wherein receiving character set independent information about a participant includes receiving a user selectable icon that may be selected to receive additional information about a participant.

4. The method of claim 1 wherein receiving character set independent information about a participant includes receiving an image file identifying a participant.

5. The method of claim 3 including enabling the user to select an icon to receive additional information about a participant.

6. An article comprising a medium storing instructions that enable a processor-based system to:
receive character set independent information about a participant in an ad hoc wireless network; and
display said information to enable selection of a participant for a communication.

7. The article of claim 6 further storing instructions that enable the processor-based system to receive an audio file that identifies a participant.

8. The article of claim 6 further storing instructions that enable the processor-based system to receive a user selectable icon that may be selected to receive additional information about a participant.

9. The article of claim 6 further storing instructions that enable the processor-based system to receive an image file identifying a participant.

10. The article of claim 8 further storing instructions that enable the processor-based system to enable the user to select an icon to receive additional information about a participant.

11. A system comprising:
a processor; and
a storage coupled to said processor storing instructions that enable the processor to handle character set independent information about a participant in an ad hoc wireless network and display said information to enable selection of a participant for a communication.

12. The system of claim 11 wherein said storage stores instructions that enable the processor to receive an audio file that identifies a participant.

13. The system of claim 11 wherein said storage stores instructions that enable the processor to generate a user selectable icon that may be selected to receive additional information about a participant.

14. The system of claim 11 wherein said storage stores instructions that enable the processor to generate an image identifying a participant.

15. The system of claim 13 wherein said storage instructions that enable the processor to allow the user to select an icon to receive additional information about a participant.

16. A method comprising:
receiving character set independent information about a participant in an ad hoc wireless network; and
automatically transmitting said character set independent information about a participant to other participants in the ad hoc wireless network.

17. The method of claim 16 wherein receiving character set independent information about a participant includes receiving an audio file that identifies a participant.

18. The method of claim 16 wherein receiving character set independent information about a participant includes receiving a user selectable icon that may be selected to receive additional information about a participant.

19. The method of claim 18 including enabling a participant to select an icon to receive additional information about another participant.

20. The method of claim 16 wherein receiving character set independent information about a participant includes receiving an image file identifying a participant.

21. An article comprising a medium storing instructions that enable a processor-based system to:
receive character set independent information about a participant in an ad hoc wireless network; and
automatically transmit said information to other participants.

22. The article of claim 21 further storing instructions that enable the processor-based system to receive an audio file that identifies a participant.

23. The article of claim 21 further storing instructions that enable the processor-based system to receive a user selectable icon that may be selected to receive additional information about a participant.

24. The article of claim 23 further storing instructions that enable the processor-based system to enable a participant to select an icon to receive additional information about another participant.

25. The article of claim 21 further storing instructions that enable the processor-based system to receive an image file identifying a participant.

26. A system comprising:
a processor; and
a storage coupled to said processor storing instructions that enable the processor to handle character set independent information about a participant in an ad hoc wireless network and transmit said information to other participants.

27. The system of claim 26 wherein said storage stores instructions that enable the processor to receive an audio file that identifies a participant.

28. The system of claim 26 wherein said storage stores instructions that enable the processor to generate a user selectable icon that may be selected to receive additional information about a participant.

29. The system of claim 28 wherein said storage instructions that enable the processor to allow a participant to select an icon to receive additional information about another participant.

30. The system of claim 26 wherein said storage stores instructions that enable the processor to generate an image identifying a participant.
